(19) United States
(12) Patent Application Publication
(10) Pub. No.: US 2020/0325998 A1
(43) Pub. Date: Oct. 15, 2020

(54) SMALL DIAMETER RADIAL SEALING ELEMENT SEALING CONFIGURATION

(71) Applicant: Hamilton Sundstrand Corporation, Charlotte, NC (US)

(72) Inventors: Mark A. Zaffetti, Suffield, CT (US); Timothy Sauerhoefer, Broad Brook, CT (US); Christopher H. Miller, West Springfield, MA (US)

(21) Appl. No.: 16/379,993

(22) Filed: Apr. 10, 2019

(51) Int. Cl. F16K 5/04; F16K 27/06

(52) U.S. Cl. CPC F16K 5/0407; F16K 5/0478; F16K 27/065

(57) ABSTRACT

A plug that can seal an aperture in a body includes a base, a main plug portion extending outward from the base, a groove body portion extending from a distal end of the main plug portion and having an outer diameter and a cap receiving portion extending from a distal end of the groove body portion and having a smaller outer diameter than the outer diameter of the groove body portion. The plug also includes a cap installed on the cap receiving portion and a radial sealing element disposed between the cap and the distal end of the main plug portion, the radial sealing element having an inner diameter that is larger than the outer diameter of the cap receiving portion. In operation, the cap is installed onto the cap receiving portion after the radial sealing element has been attached.

### STATEMENT OF FEDERAL SUPPORT

This invention was made with government support under NNJ06TA25C, Sub-Contract RH6-118203 awarded by NASA. The government has certain rights in the invention.

### BACKGROUND

Exemplary embodiments pertain to the art of seals and, in particular, to a seal that utilizes a small diameter radial sealing element such as an O-ring.

Providing seals in certain location is important in many industries. There are several different way to seal, for example, a circular opening. For example, the aperture can be sealed by inserting a plug formed of a rigid material therein. However, for a more robust seal, the plug can include a groove into which an O-ring sits. The groove has a smaller diameter than the remainder of the plug. To get the O-ring over the retaining lip that defines one side of the groove, the O-ring must be stretched. With small diameter O-rings, the amount the O-ring must be stretched to pass over the retaining lip during installation may exceed industry limits and, thus, compromise the O-ring's ability to seal.

### BRIEF DESCRIPTION

Disclosed is a plug for sealing an aperture in a body. The plug includes a base, a main plug portion extending outward from the base and a groove body portion extending from a distal end of the main plug portion and having an outer diameter. The plug also includes cap receiving portion extending from a distal end of the groove body portion and having a smaller outer diameter than the outer diameter of the grove body portion, a cap installed on the cap receiving portion, and a radial sealing element disposed between the cap and the distal end of the main plug portion, the radial sealing element having an inner diameter that is larger than the outer diameter of the cap receiving portion.

In one aspect, in a plug of any prior embodiment, the radial sealing element is formed of an elastomeric material.

In one aspect, in a plug of any prior embodiment, the radial sealing element is an O-ring.

In one aspect, in a plug of any prior embodiment, the cap is formed of a rigid material.

In one aspect, in a plug of any prior embodiment, the cap is formed of the same material as the main body portion.

In one aspect, in a plug of any prior embodiment, the cap is press fit on to the cap receiving portion.

In one aspect, in a plug of any prior embodiment, the cap is chemically bonded on to the cap receiving portion.

In one aspect, in a plug of any prior embodiment, the cap is threaded onto the cap receiving portion.

In one aspect, in a plug of any prior embodiment, the main plug portion has an outer diameter that is greater than the outer diameter of the groove body portion.

In one aspect, in a plug of any prior embodiment, the cap has an outer diameter that is the same as the outer diameter of the outer diameter of the main plug portion.

In one aspect, in a plug of any prior embodiment, the cap abuts the distal end of the groove body portion

In another embodiment, a method of sealing an aperture is disclosed. The method includes providing a plug that includes: a base, a main plug portion extending outward from the base, a groove body portion extending from a distal end of the main plug portion and having an outer diameter, and a cap receiving portion extending from a distal end of the groove body portion and having a smaller outer diameter than the outer diameter of the groove body portion. The method also includes installing a radial sealing element on the groove body portion; after installing the radial sealing element, installing a cap on the cap receiving portion; and installing the plug into the aperture.

In one aspect, in a method of any prior embodiment, the cap is installed such that it abuts the distal end of the groove body portion.

In one aspect, in a method of any prior embodiment, the radial sealing element has an inner diameter that is larger than the outer diameter of the cap receiving portion and smaller than the outer diameter of the groove body portion.

In one aspect, in a method of any prior embodiment, the radial sealing element is an O-ring and the aperture is formed in a heat exchanger.

### BRIEF DESCRIPTION OF THE DRAWINGS

The following descriptions should not be considered limiting in any way. With reference to the accompanying drawings, like elements are numbered alike:

FIG. 1 is a cross-sectional side view of a plug installed in an aperture;

FIG. 2 is a perspective view of the plug of FIG. 1;

FIG. 3 is a cross-sectional side view of another plug installed in an aperture;

FIG. 4 is a perspective view of the plug and radial sealing element of FIG. 3; and

FIG. 5 is a perspective view of the plug of FIG. 4 after a radially sealing element and a cap have been installed thereon.

### DETAILED DESCRIPTION

A detailed description of one or more embodiments of the disclosed apparatus and method are presented herein by way of exemplification and not limitation with reference to the Figures.

According to one embodiment, a plug-type sealing apparatus (sealing apparatus) is provided that includes a radial sealing element such as an O-ring. In one embodiment, and based on the following discussion, the radial sealing apparatus can be provide on the sealing apparatus such that it does not need to be expanded or such that it is expanded within a tolerance (e.g., less than 50% of the materials forming the radial sealing apparatus' elongation at rupture specification). The plug can be used to seal an aperture formed in a body.

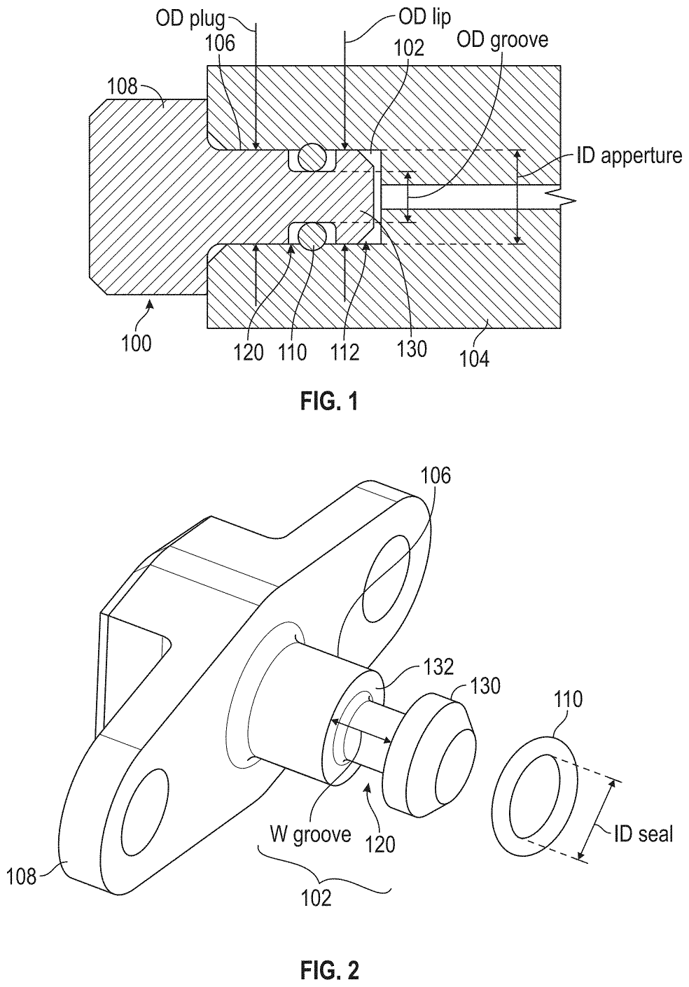

By way of further background, a side cross-sectional view of one manner utilizing a plug-type sealing member (sealing member) that includes radial sealing element is shown in FIG. 1. The sealing apparatus 100 (or at least a portion thereof) is inserted into a generally cylindrical aperture 102 formed in a body 104 and seals a fluid or other material in the body 104. For example, the sealing apparatus 100 could seal wax in either solid or liquid form in a phase change material (PCM) heat exchanger. Indeed, any embodiment disclosed herein can below be utilized in such a situation.

As illustrated, the sealing apparatus 100 includes a plug 106 that extends from a base 108. The plug 106 is inserted in the aperture 102 formed in the body 104. The aperture 102, as illustrated, has an inner diameter IDaperture. A radial sealing element 110 surrounds a portion of the plug 106. When the plug 106 is inserted into the aperture 102, the radial sealing element 110 contacts an outer wall 112 of the aperture 102 such that a seal is created and a fluid, gas or liquid is prevented from passing between the outer wall 112 of the aperture 102 and thereby exiting the body 104. As described further below, the inner diameter of the radial sealing element 110 seals against the outer diameter of the plug in the groove 120 to ensure that there is no leak path there between.

FIG. 2 shows the sealing apparatus 100 of FIG. 1 in a perspective view. The following discussion refers to both FIGS. 1 and 2 simultaneously. The plug 106 can include groove 120 that has an outer diameter ODgroove. The width (Wgroove) of the groove 120 is defined between a retaining lip 130 and a groove wall 132 formed in the plug 106. The retaining lip 130 has an outer diameter of ODlip.

To allow of seating of the radial sealing element 110 within the groove 120, the outer diameter of the groove 120 (ODgroove) is less than both the outer diameter of the plug 106 (ODplug) and the outer diameter of the retaining lip 122 (ODlip).

With reference to FIG. 2, in practice the radial sealing element 110 has a natural or un-stretched inner diameter IDseal. To ensure a good seal the natural inner diameter of the radial sealing element 110 (IDseal) is less than the outer diameter of the groove 120 (ODgroove) and is less than both the outer diameter of the plug 106 (ODplug) and the outer diameter of the retaining lip 122 (OD lip). In order to get the radial sealing element 110 to sit in the groove 120, the radial sealing element 110 must be stretched such that its inner diameter exceeds the outer diameter of the retaining lip 122 (ODlip).

The material forming the radial sealing element 110 is thus elongated during installation. If the radial sealing element 110 elongation is too great it may interfere with its ability to seal. To allow for installation (including the needed ability for local stretching, spiraling or twisting) the elongation per unit length is usually kept below an industry standard of about 50% of the material's elongation at rupture. Elongation increases in importance as the diameters of a sealing member become smaller. At these small diameters, the stretching of the radial sealing element 110 during installation may impact the ability of it to recover from a peak force or generate a localized load in one small area of the radial sealing element 110, either of which could compromise the radial sealing element 110 ability to seal. Disclosed below is an embodiment of a sealing member that allows the use of small sealing members (such as O-rings) without creating excess elongation of the radial sealing element 110 during installation.

Herein disclosed is a sealing apparatus that allows for a radial sealing member to be placed on the a plug portion thereon without having to excessively stretch or otherwise elongate the radial sealing member when placing the radial sealing element onto the sealing apparatus.

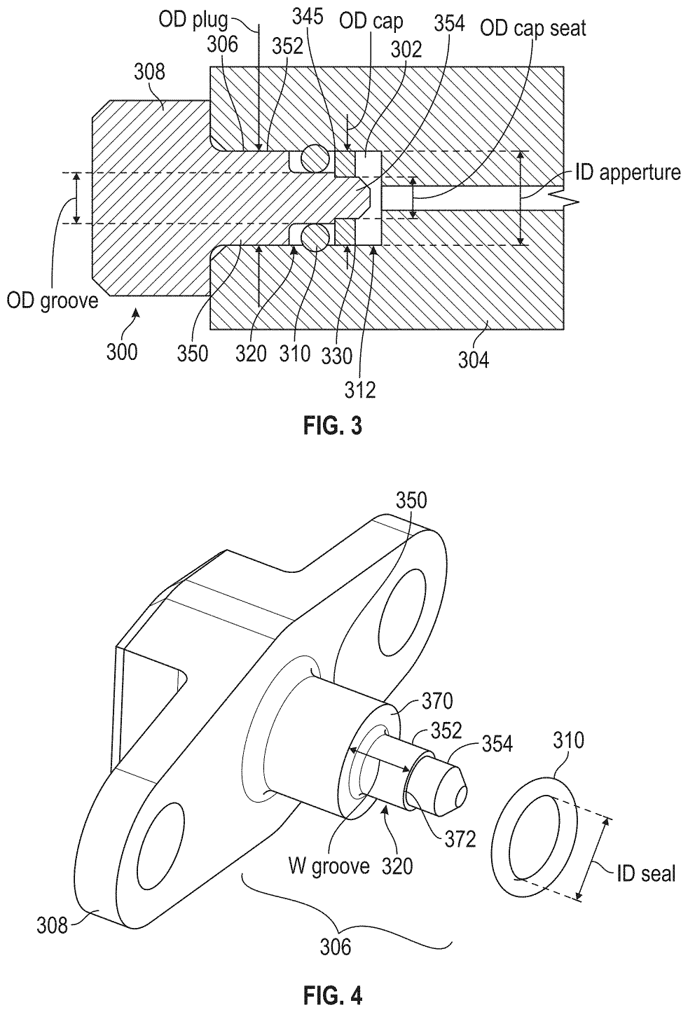

FIG. 3 shows a cross sectional view of one embodiment of sealing apparatus 300 and FIG. 4 shows a portion the sealing apparatus 300 of FIG. 3 (excluding the cap 345) in a perspective view. The following discussion refers to both FIGS. 3 and 4 simultaneously.

The sealing apparatus 300 (or at least a portion thereof) is inserted into a generally cylindrical aperture 302 formed in a body 304 and seals a fluid or other material in the body 304. For example, the sealing apparatus 300 could seal wax in either solid or liquid form in the body 304. The body 304 can be, for example, a heat exchanger and, in particular, a phase change material (PCM) heat exchanger.

As illustrated, the sealing apparatus 300 includes a plug 306 that extends from a base 308. To seal fluid/liquid in the body 304, the plug 306 is inserted in the aperture 302 formed in the body 304. As best seen in FIG. 4, the plug 306 includes a main plug portion 350, a groove body portion 352 extending from a distal end 370 of the main plug portion 350, and a cap receiving portion 354 extending from a distal end 372 of the groove body portion 352.

Similar to the above, the aperture 302, as illustrated, has an inner diameter IDaperture. A radial sealing element 310 surrounds a portion of the plug 306. The radial sealing element 310 can be formed of an elastomeric material in one embodiment. The radial sealing element 310 can be an O-ring in one embodiment.

When the plug 306 is inserted into the aperture 302, the radial sealing element 310 contacts an outer wall 312 of the aperture 302 such that a seal is created and a fluid, gas or liquid is prevented from passing between the outer wall 312 of the aperture 302 and thereby exiting the body 304. Of course, the sealing element 310 contacts the groove body portion 352 to prevent leakage along the groove body portion.

As opposed to having the fixed retaining lip of FIGS. 1-2, the sealing apparatus includes a cap 330 that is attached a distal end of the plug 306 after the radial sealing element 310 is installed on the plug 306. The cap 330 keeps the radial sealing element 310 seated on the plug 306 (e.g., in the groove 320 described below) after it has been installed.

With reference again to FIGS. 3 and 4, the cap 330 is initially removable or not otherwise connected to the plug 306. The cap 330, when installed, will define one side of a groove 320 in which the radial sealing element 310 sits after it is installed. The groove 320 surrounds the groove body portion 352 and the other side of the groove 320 is defined by a distal end 370 of the main plug portion 350

When the cap 330 is attached to the plug 306 the groove 320 is defined. The groove body portion 352 has an outer diameter ODgroove. The width (Wgroove) of the groove 320 is defined between an interior side 345 of the cap 330 and the distal end 370 of the main body portion 350. The same width can also be defined between the distal end 370 of the main body portion 350 and the distal end 372 of the groove body portion 352.

In practice, the radial sealing element 310 is slightly stretched as it is installed on to groove body portion 352. That is, outer diameter of the groove body portion 352 (ODgroove) is greater than natural inner diameter (IDseal) of the radial sealing element 310. The outer diameter of the cap receiving portion 354 (ODcapseat) is less than the outer diameter of the groove body portion 352 (ODgroove) and natural inner diameter (IDseal) of the radial sealing element 310 and, thus, does not require stretching the radial sealing element 310 during the installation. That is, the only required stretching to radial sealing element 310 is due to it having to surround the groove body portion 352

As mentioned above, the plug 306 includes cap receiving portion 354 extending from a distal end 372 of the groove body portion 352. A cap 330 is installed on to the cap receiving portion 354 after the radial sealing element 310 has been installed on to groove body portion 352 and, in one embodiment, abuts the distal end 372 of the groove body portion 352. In this manner, the radial sealing element 310 is maintained in the groove 320 and its installation therein did not require undue or extreme stretching of the radial sealing element 310.

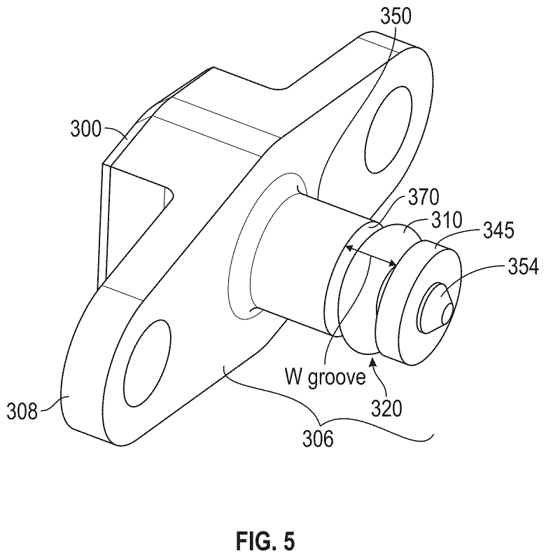

FIG. 5 shows a perspective view of a sealing apparatus 300 of FIG. 3 with cap 345 installed on the cap receiving portion 354. The cap 345 will keep the radial sealing element 310 on the sealing apparatus 300 when installed in an aperture.

The cap 345 can be formed of a rigid material and, in one embodiment, is formed on the same or a similar material as the plug 306. The cap 345 can be held on the cap receiving portion 354 by a press fit, chemical or other bonding, threads or other retaining element.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A plug for sealing an aperture in a body, the plug comprising:
a base;
a main plug portion extending outward from the base;
a groove body portion extending from a distal end of the main plug portion and having an outer diameter;
a cap receiving portion extending from a distal end of the groove body portion and having a smaller outer diameter than the outer diameter of the groove body portion;
a cap installed on the cap receiving portion; and
a radial sealing element disposed between the cap and the distal end of the main plug portion, the radial sealing element having an inner diameter that is larger than the outer diameter of the cap receiving portion.

2. The plug of claim 1, wherein the radial sealing element is formed of an elastomeric material.

3. The plug of claim 2, wherein the radial sealing element is an O-ring.

4. The plug of claim 1, wherein the cap is formed of a rigid material.

5. The plug of claim 4, wherein the cap is formed of the same material as the main body portion.

6. The plug of claim 1, wherein the cap is press fit on to the cap receiving portion.

7. The plug of claim 1, wherein the cap is chemically bonded on to the cap receiving portion.

8. The plug of claim 1, wherein the cap is threaded onto the cap receiving portion.

9. The plug of claim 1, wherein the main plug portion has an outer diameter that is greater than the outer diameter of the groove body portion.

10. The plug of claim 9, wherein the cap has an outer diameter that is the same as the outer diameter of the outer diameter of the main plug portion.

11. The plug of claim 1, wherein the cap abuts the distal end of the groove body portion.

12. A method of sealing an aperture, the method comprising:
providing a plug that includes: a base, a main plug portion extending outward from the base, a groove body portion extending from a distal end of the main plug portion and having an outer diameter; and a cap receiving portion extending from a distal end of the groove body portion and having a smaller outer diameter than the outer diameter of the groove body portion;
installing a radial sealing element on the groove body portion;
after installing the radial sealing element, installing a cap on the cap receiving portion; and
installing the plug into the aperture.

13. The method of claim 12, wherein the cap is installed such that it abuts the distal end of the groove body portion.

14. The method of claim 12, wherein the radial sealing element has an inner diameter that is larger than the outer diameter of the cap receiving portion and smaller than the outer diameter of the groove body portion.

15. The method of claim 12, wherein the radial sealing element is an O-ring and the aperture is formed in a heat exchanger.
